(19) United States
(12) Patent Application Publication
(10) Pub. No.: US 2009/0084107 A1
(43) Pub. Date: Apr. 2, 2009

(54) HYDROGEN POWERED STEAM TURBINE

(75) Inventor: James Y. Gleasman, Rochester, NY (US)

Correspondence Address: MORTON A. POLSTER;BROWN & MICHAELS, P.C., 400 M & T BANK BUILDING, 118 N. TIOGA STREET, ITHACA, NY, 14850, US

(73) Assignee: Torvec, Inc, Rochester, NY (US)

(21) Appl. No.: 12/238,974

(22) Filed: Sep. 26, 2008

Related U.S. Application Data
(60) Provisional application No. 60/975,665, filed on Sep. 27, 2007.

(51) Int. Cl. F01K 13/00; B01J 19/10; C01B 3/02

(52) U.S. Cl. 60/670; 60/645; 204/157.42; 204/157.52

(57) ABSTRACT

A process provides energy from a hydrogen flame to produce ultra high temperature steam, which is water vapor having a temperature over 1200° C., as an energy transfer medium to drive a steam turbine. The hydrogen fuel may be supplied to the system from a source of isolated hydrogen such as compressed or liquefied H₂, but is more preferably generated near its site of combustion by irradiating an aqueous solution of one or more inorganic salts or minerals with radiofrequency electromagnetic radiation having a spectrum and intensity selected for optimal hydrogen production. The ultra high temperature steam is produced by contacting the hydrogen flame and its combustion gases with surfaces in a ceramic steam generation unit. In one embodiment, a radiofrequency generator produces hydrogen gas from sea water to provide hydrogen fuel to produce steam to drive the turbine.

### REFERENCE TO RELATED APPLICATIONS

This application claims one or more inventions which were disclosed in Provisional Application No. 60/975,665, filed Sep. 27, 2007, entitled “HYDROGEN POWERED STEAM TURBINE”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of energy generation. More particularly, the invention pertains to a system for converting gaseous hydrogen fuel to electricity.

2. Description of Related Art

There is increasing interest in the use of hydrogen gas as a fuel. Hydrogen is potentially plentiful and, since water is the only by-product of its combustion, it is the cleanest burning of all fuels. Fossil fuels, meanwhile, are increasingly scarce and expensive, and increasing awareness of global warming and other undesirable effects of burning carbon-based fuels makes their continued use problematic.

Hydrogen gas burns with intense heat. In air, hydrogen burns with a flame temperature of 2045° C. In contrast, methane (natural gas) burns at only 1325° C. Hydrogen can therefore be used to produce steam at a higher temperature than is achievable with fossil fuel fired boilers.

One challenge associated with hydrogen fuel is the fact that hydrogen—though abundant on earth—does not occur in its elemental form H₂ in any useful quantity. As such, in order to utilize hydrogen as a fuel it must be manufactured. This is most commonly done by steam reformation of methane (the syngas process) or electrolysis of water. It presently takes more energy to produce H₂ than is obtained by burning the gas. Recent developments utilizing radio frequency electromagnetic radiation to produce hydrogen from aqueous solutions such as sea water hold promise that the production of hydrogen can be made more efficient. A radiofrequency transmitter is described in International Publication No. WO 2005/120639, by John Kanzius et al., published Dec. 22, 2005. Details of the process are disclosed in “Salt Water Can ‘Burn,’ Scientist Confirms” by John Roach, Nation Geographic News, Sep. 14, 2007, which are incorporated herein by reference.

### SUMMARY OF THE INVENTION

The present invention is directed to a process for producing energy from a hydrogen flame. The process relies on ultra high temperature steam, which is water vapor having a temperature over 1200° C., as an energy transfer medium. The hydrogen fuel is generated near its site of combustion by irradiating a water solution of one or more inorganic salts or minerals with radio frequency electromagnetic radiation at a frequency and intensity selected to maximize the production of combustible hydrogen per unit of electromagnetic energy input to the system. The ultra high temperature steam is produced by contacting the hydrogen flame and its combustion gases with heat exchange surfaces in a ceramic steam generation unit. The ultra high temperature steam is used as an energy transfer medium to drive one or more steam turbines. The steam turbines may be coupled to an electrical generator, a vehicular drive, or any similar application to which turbine power is typically coupled. In one embodiment, the steam driven turbine is coupled to a radiofrequency generator capable of producing hydrogen gas from sea water.

### BRIEF DESCRIPTION OF THE DRAWINGS

FIG. 1 shows a block diagram of an embodiment of the present invention.

### DETAILED DESCRIPTION OF THE INVENTION

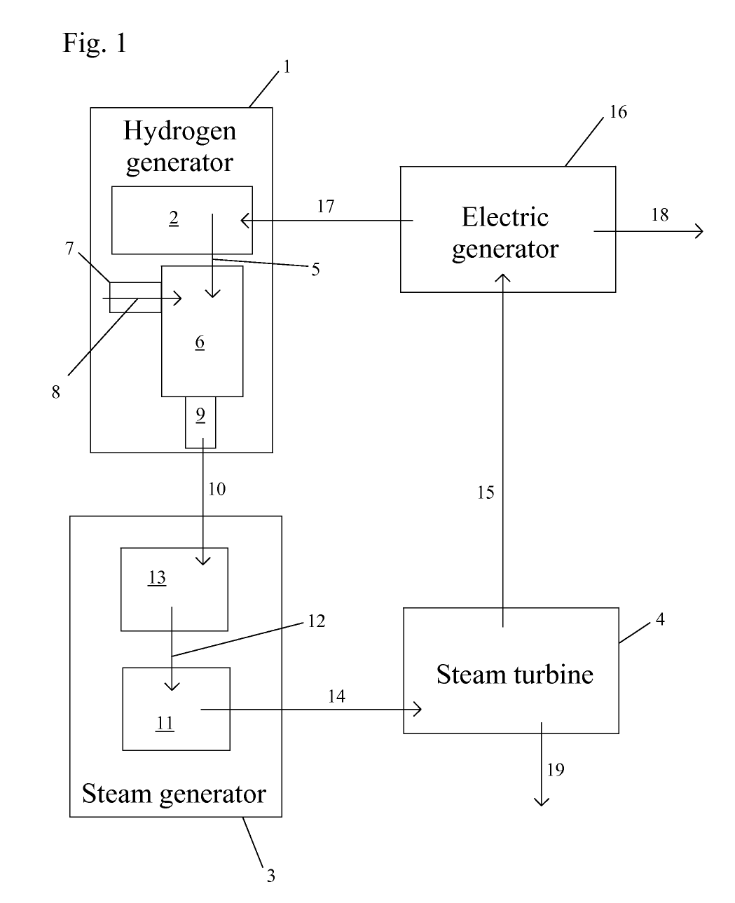

Referring to FIG. 1, an apparatus of the present invention preferably includes four main components: a hydrogen generator 1, a radiofrequency generator 2, a hydrogen-fired ultra high temperature steam generator 3, and a steam turbine 4. The steam turbine is driven by ultra high temperature steam which is generated by contacting liquid water or steam with the heat generated by burning hydrogen from the hydrogen generator. Ultra high temperature steam for the purposes of the present invention is defined as water vapor having a temperature above 1200° C.

### Hydrogen Generation

Hydrogen gas is currently produced commercially from hydrocarbons (via syngas) or from water (via electrolysis). Each of these processes is energy intensive and relatively inefficient. A newer hydrogen generation process relies on irradiation of aqueous solutions of inorganic salts to liberate hydrogen. This process is the preferred hydrogen source for the present invention. Laboratory scale experiments have demonstrated that a combustible hydrogen-containing gas can be generated directly from sea water by irradiation with radio frequency radiation of appropriate wavelength and intensity. The present invention couples this process directly with an ultra high temperature steam generation unit.

The hydrogen generator 1 preferably includes a tuned radio frequency field 5, a reservoir of electrolyte 6, an inlet 7 for makeup water 8, and a hydrogen gas outlet 9. The temperature of the electrolyte in the reservoir is preferably monitored and maintained at a temperature below its boiling point.

The electrolyte in the hydrogen generator 1 is a water solution containing dissolved ions. Preferably the ions are provided by one or more inorganic salts. More preferably, the electrolyte includes halides of alkali metals, still more preferably the electrolyte includes sodium chloride. One specific electrolyte solution particularly suitable for the present invention is natural sea water.

In a preferred embodiment, the hydrogen generator operates in a ‘flow-through’ mode where electrolyte flows through the hydrogen generator. Such a flow-through design is particularly convenient if a source of sea water is available. If the flow is maintained at a sufficient rate, then no additional cooling of the electrolyte is required.

### Radio Frequency Source

The radio frequency source 2 must be able to provide an output 5 with a frequency spectrum appropriate to generate hydrogen from the specific electrolyte being used, and must have sufficient output wattage to generate hydrogen at a rate matched to the consumption rate of the burner in the steam generator 3. Preferably the radio frequency source 2 is tunable to allow optimization of hydrogen production with various salt solutions. More preferably, the radio frequency source has an output tunable over the frequency range from about 300 MHz to about 1000 GHz. Preferably radio frequency source 2 has a variable output intensity so that the rate of hydrogen flow from the generator may be modulated.

The hydrogen gas 10 produced by the generator may optionally be combusted immediately upon generation. A hydrogen flame may be sustained within the radiofrequency field within the hydrogen generator. Thus, in a preferred embodiment, the headspace above the electrolyte bath is continuous with one of more hydrogen combustion chambers of the steam generator 3. In this way, there is no requirement to isolate or transfer the hydrogen gas prior to combustion. In designs of this type, heating of the electrolyte bath by radiant energy from the burner is preferably minimized. In one embodiment a hydrogen-porous insulating material is located on or near the surface of the electrolyte solution to minimize heat transfer to the bath.

### Steam Generation

Prior art boilers are generally not compatible with temperatures in excess of about 700° C. This limitation is due primarily to the fact that the materials from which boilers are constructed are not compatible with higher temperatures.

Boilers 11 of the present invention are preferably constructed of high temperature refractory ceramics capable of withstanding hydrogen flame temperatures (e.g. at least 2000° C.). Ceramic compositions suitable for constructing boiler components of the present invention include, but are not limited to, aluminum oxide, aluminum titanate, zirconium oxide, zirconia (ZrSiO₄), silicon dioxide, magnesium oxide, yttrium oxide, silicon carbide, silicon nitride, silicon aluminum oxinitride (sialon), tungsten carbide, boron nitride, as well as composites and mixtures of the above materials.

The ultra high temperature steam is generated by thermally coupling 12 a source of liquid water or steam to the hydrogen flame of the burner 13. Where steam is the feed stream heated by the hydrogen flame, it may be provided by a lower temperature steam generator and then heated by the hydrogen flame to increase its temperature to at least 1200° C. The steam fed to the hydrogen-fired boiler may also be generated by contacting spent stream from the exhaust of a turbine driven by ultra high temperature steam with feed water such that the water is vaporized. In another embodiment, a portion of the steam may be provided directly from the water vapor formed by the combustion of the hydrogen gas. In this way, additional thermal energy from the combustion may be captured in the steam output from the generator.

The geometry of the ceramic heat exchanging elements of the boiler may be of traditional tube designs as are well known in the art. Suitable prior art boiler geometries may be found in Steam: its generation and use, S. C. Stultz and J. B. Kitto (eds.), Babcock and Wilcox Co., Barberton, Ohio 1992, which is incorporated herein by reference. More preferably, the steam generator includes a monolithic block of ceramic material having channels, in which hydrogen is combusted, interleaved with passages through which steam circulates and is heated. Preferably in this system, the entire block of ceramic material is maintained at the desired steam temperature, and the hydrogen combustion rate is modulated to balance the flow rate of steam entering the boiler.

Since many ceramics increase in thermal conductivity at very high temperatures, a boiler of this design more efficiently transfers energy to the steam as the temperature of the system increases and the monolithic ceramic block becomes a more efficient conductor. Zirconium dioxide has a very low thermal conductivity at room temperature, but is an excellent thermal conductor at higher temperatures. Table 1 shows that the thermal conductivity of zirconium dioxide is about 0.5 BTU-in/hr-ft²-° F. in air at 500° F. but increases to 1.25 BTU-in/hr-ft²-° F. at 2000° F., the approximate temperature of a hydrogen flame.

TABLE 1
Increase in Thermal Conductivity of Zirconia
with Increasing Temperature

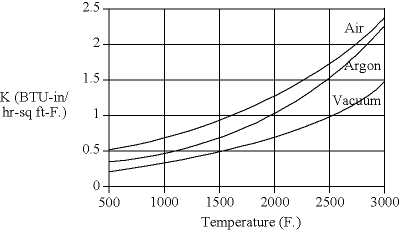

The steam generator may be operated at sub- or super-critical pressures (less than 22.1 MPa or greater than 22.1 MPa, respectively). Normally, operation at supercritical pressures results in higher overall turbine efficiencies. Additional strategies for steam generation from hydrogen combustion which may be used in the present invention are discussed by H. Jin and M. Ishida in “A novel gas turbine cycle with hydrogen-fueled chemical-looping combustion” International Journal of Hydrogen Energy 25 (2000) 1209-1215, which is incorporated herein by reference.

### Steam Turbines

Ultra high temperature steam 14 is directed from the steam generator 3 under pressure to one or more steam turbines 4. Normally, several turbine stages are coupled in series to capture as much energy as possible from a steam source. Preferably the first stage turbine contacting the ultra high temperature steam feed from the steam generator is constructed from refractory materials able to withstand temperatures of at least 1200° C. More preferably, at least one turbine stage is capable of withstanding temperatures of at least 1500° C. The steam is at a lower temperature in any subsequent turbine stage so, depending on the design of the first stage, it may be possible to use second and third stage turbines constructed from traditional materials. The details of turbine design are well known and details of turbine designs suitable for the present invention may be found in A Practical Guide to Steam Turbine Technology by Heinz P. Bloch, 1995, which is incorporated herein by reference.

The turbine is preferably coupled 15 to an electric generator 16. The details of such generators and their coupling to turbines is well known in the prior art. Optionally, a portion of the energy output 17 from the electric generator may be coupled back to the radiofrequency source of the hydrogen generator. The remainder of the electrical energy 18 is preferably used to perform work.

Alternately, the turbine may be coupled directly 19 to a device to perform mechanical work. A particularly suitable application of a system of the present invention is to power an ocean going vessel, since a vast supply of sea water would be available to circulate through the electrolyte chamber of the hydrogen generator. The apparatus described above may be adapted to a variety of other purposes where ultra high temperature steam, electricity, or mechanical power or a combination thereof need to be provided by a compact self-contained system.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for generating power comprising:
a) a hydrogen generator for generating a hydrogen fuel;
b) a steam generator comprising a burner for burning the hydrogen fuel to heat a water source, thereby generating an ultra high temperature steam; and
c) at least one steam turbine driven by the ultra high temperature steam to generate power.

2. The system of claim 1, wherein the hydrogen generator comprises:
a) a reservoir for containing an aqueous electrolyte solution;
b) a radio frequency generator for generating a radio frequency to be applied to the aqueous electrolyte solution;
c) an inlet for receiving additional solution in the reservoir; and
d) a hydrogen gas outlet coupled to the steam generator.

3. The system of claim 2, wherein the radio frequency generator is tunable such that the radio frequency is selected to maximize production of the hydrogen fuel per unit of electromagnetic energy input from the radio frequency generator.

4. The system of claim 3, wherein the radio frequency generator is tunable in a frequency range of about 300 MHz to about 1000 GHz.

5. The system of claim 2, wherein the aqueous electrolyte solution is sea water.

6. The system of claim 2, wherein the aqueous electrolyte solution is continuously flowing through the reservoir.

7. The system of claim 2, wherein the radio frequency generator is operatable at a wattage such that a rate of generation of the hydrogen matches a consumption rate of the hydrogen in the burner.

8. The system of claim 1, wherein the steam generator further comprises a boiler for applying heat from the burner to the water source.

9. The system of claim 8, wherein the boiler is constructed of a high temperature refractory ceramic material selected from the group consisting of aluminum oxide, aluminum titanate, zirconium oxide, zirconia, silicon dioxide magnesium oxide, yttrium oxide, silicon carbide, silicon nitride, silicon aluminum oxinitride, tungsten carbide, boron nitride, and any combination of the above materials.

10. The system of claim 1, wherein the steam turbine is coupled to an electric generator.

11. The system of claim 1O, wherein the electric generator provides energy to run the radio frequency generator.

12. A method of generating power comprising the steps of:
a) generating a hydrogen fuel;
b) burning the hydrogen fuel to heat a water source to form an ultra high temperature steam; and
c) driving a steam turbine using the ultra high temperature steam.

13. The method of claim 12, wherein the step of generating a hydrogen fuel comprises the sub-step of applying a radio frequency to an aqueous electrolyte solution to produce the hydrogen fuel.

14. The method of claim 13, wherein the step of generating a hydrogen fuel further comprises the sub-step of tuning the radio frequency to maximize production of the hydrogen fuel per unit of electromagnetic energy input.

15. The method of claim 12 further comprising the step of driving an electric generator using the steam turbine.

16. The method of claim 15 further comprising the step of driving the radio frequency generator using the electric generator.

17. The method of claim 12 further comprising the step of driving a device used to perform mechanical work using the steam turbine.
